(19) United States
(12) Patent Application Publication
(10) Pub. No.: US 2013/0130399 A1
(43) Pub. Date: May 23, 2013

(54) CO2 Indicator

(71) Applicants: Andrew Mills, Belfast (GB); Graham Skinner, Glasgow (GB)

(72) Inventors: Andrew Mills, Belfast (GB); Graham Skinner, Glasgow (GB)

(21) Appl. No.: 13/697,734

(22) PCT Filed: May 12, 2011
(86) PCT No.: PCT/GB11/00725

§ 371 Date: Jan. 28, 2013

(30) Foreign Application Priority Data
May 13, 2010 (GB) 1007980.4

(51) Int. Cl. G01N 31/22

(52) U.S. Cl. CPC G01N 31/224
USPC 436/133; 206/459.1; 220/212; 116/206

(57) ABSTRACT

A chemical indicator or ink, and methods for manufacture thereof, comprises at least one carbon dioxide-sensitive reactive dye which is capable of detecting changes in carbon dioxide concentration in a fluid under fluid and/or gas phase pressure of carbon dioxide above approximately (1) bar. The present chemical indicators or inks are useful in the monitoring of relatively high carbon dioxide pressure environments, such as in carbonated drinks. The present invention also relates to containers for holding a carbonated liquid, and closures therefore, comprising a carbon dioxide indicator or a carbon dioxide-sensitive ink, wherein the carbon dioxide indicator and/or the ink comprises at least one carbon dioxide-sensitive reactive dye which is capable of detecting changes in carbon dioxide concentration in a fluid under fluid and/or gas phase pressure of carbon dioxide above approximately (1) bar.

### FIELD OF INVENTION

The present invention relates to chemical inks or indicators, e.g. carbon dioxide-sensitive reactive inks or indicators, comprising a chemical dye, e.g. a carbon dioxide reactive dye, and capable of detecting changes in carbon dioxide concentration in a fluid (liquid and/or gas) under high fluid (or only gas phase) pressure, e.g. at pressures of CO₂ above approximately 1 bar.

The present invention also relates to a method of preparing such chemical inks comprising providing at least one suitable carbon dioxide dye and at least one suitable solvent.

The present invention also relates to a method of preparing such chemical indicators comprising applying, e.g. coating, one or more such chemical ink onto a substrate.

The present invention also relates to the use of such chemical inks or indicators in the monitoring of relatively high carbon dioxide pressure environments, e.g. carbonated drinks, brewing, fermentation, propellant-dispensing products, grain storage, industrial decaffeination of coffee, refrigeration, monitoring pressure of carbon dioxide as a raw material in industrial chemical reactions, carbon dioxide dry cleaning, fire extinguishers, carbon dioxide gas cylinders, bakeries, industrial fermentation in biotechnology, e.g. for drug manufacture.

### BACKGROUND TO INVENTION

Colourimetric indicators are a well-known means of detecting the presence of a chemical substance in a particular medium. This type of indicator includes, e.g., pH indicators which exhibit a colour change as the pH of the medium in which it is placed varies.

Such indicators rely on the optical properties of reactive dyes or inks. These dyes can exist in at least two different chemical states, with each form of the dye absorbing light in a particular range of wavelengths. When such a reactive dye existing in a first form is exposed to a substance of a particular pH, it reacts via a reversible chemical reaction, thereby turning into a second form of the dye. As the second form of the dye absorbs light at a different wavelength, the chemical reaction provides a colour change which is visible by an observer.

The use of colourimetric indicators thus potentially provides an attractive solution to the problem of detecting the presence of some particular chemical substances.

Such substances include gases, such as carbon dioxide. Detection of carbon dioxide is of particular significance due to its widespread use in a variety of fields and applications. While there exist examples of colourimetric CO₂ indicators which show a distinct reversible colour change in the presence of carbon dioxide, the majority of previous work has focussed on the detection of low levels/pressures of carbon dioxide, typically <<1 bar.

The majority of CO₂ colourimetric indicators are dependent upon the change in pH which occurs when CO₂ dissolves in water. In aqueous solution this observed pH change is due to the following reactions:

CO₂(g) [symbol] CO₂(aq) (1)

CO₂(aq)+H₂O [symbol] H₂CO₃ (2)

H₂CO₃+H₂O [symbol] H₃O⁺+HCO₃⁻ (3)

HCO₃⁻+H₂O [symbol] H₃O⁺+CO₃²⁻ (4)

coupled to:

D⁻(colour A)+H₃O⁺ [symbol] DH(colour B)+H₂O (5)

Thus, upon exposure of such an indicator to CO₂, the pH of the dye's ambient environment is decreased sufficiently to protonate the dye and so cause a measurable and observable change in absorbance of the indicator; the greater the partial pressure of carbon dioxide (P_{CO2}) the greater the colour change. The pKa of the pH dye is critical in determining the sensitivity, and therefore practical operating range, of the colourimetric indicator. Typically, the lower the pKa the less sensitive the CO₂ indicator.

However, there is a need in the art to develop new chemical indicators, and in particular colourimetric CO₂ indicators, to provide simple, reliable, and cost effective detection means in environments requiring monitoring and/or detection of changes in CO₂ concentrations under high pressure, e.g. at pressures of CO₂ above approximately 1 bar (10⁵ Pa).

It is an object of at least one embodiment of at least one aspect of the present invention to seek to obviate or at least mitigate one or more disadvantages in the prior art.

It is an object of at least one embodiment of at least one aspect of the present invention to provide a carbon dioxide indicator comprising at least one carbon dioxide-sensitive reactive dye which is capable of detecting changes in carbon dioxide concentration in a fluid (liquid and/or gas) under high fluid (liquid and/or gas) pressure, e.g. at pressures of CO₂ above approximately 1 bar.

It is an object of at least one embodiment of at least one aspect of the present invention to provide a method of preparing an ink comprising dissolving at least one carbon dioxide-sensitive reactive dye and at least one polymer in at least one solvent.

It is an object of at least one embodiment of at least one aspect of the present invention to provide a method of preparing such an indicator comprising applying, e.g. coating, such an ink onto a substrate.

It is an object of at least one embodiment of at least one aspect of the present invention to provide a use for such a carbon dioxide indicator or ink in detecting changes in carbon dioxide concentration in a fluid under high fluid pressure, e.g. at pressures of CO₂ above approximately 1 bar.

It is an object of at least one embodiment of at least one aspect of the present invention to provide a container for holding a carbonated liquid, such as a carbonated soft drink or alcoholic beverage, comprising such an indicator or ink.

It is an object of at least one embodiment of at least one aspect of the present invention to provide a closure, e.g. a cap or a lid, for a container for holding a carbonated liquid, such as a carbonated soft drink or alcoholic beverage, comprising such an indicator or ink.

### SUMMARY OF INVENTION

According to a first aspect of the present invention there is provided a carbon dioxide indicator comprising at least one carbon dioxide-sensitive reactive dye which is capable of detecting changes in carbon dioxide concentration in a fluid under high fluid and/or gas phase pressure, e.g. at pressures of CO₂ above approximately 1 bar (10⁵ Pa).

A reactive dye is understood to be defined as a dye that can exist in at least two different chemical states, with each form of the dye absorbing light in a particular range of wavelength. When such dyes are exposed to a given substance, they can reversibly or irreversibly react from a first chemical state into a second chemical state, thereby inducing a visible colour change. Such dyes may comprise, e.g., colourimetric and/or fluorescent reactive dyes.

The indicator may be capable of detecting changes in carbon dioxide concentration in a fluid under carbon dioxide pressure between approximately 1 bar and approximately 10 bar, and typically under carbon dioxide pressure between approximately 1 bar and approximately 5 bar.

The indicator may be liquid-proof, e.g. waterproof. By such provision the indicator may be suitable for detecting carbon dioxide in an environment comprising a liquid, e.g. a liquid and a gas, such as in a carbonated drinks container or the like.

In carbonated drinks, typical partial pressures of carbon dioxide (P_{CO2}) are shown in Table 1 below:

TABLE 1
Typical carbonation levels in carbonated drinks

| Degree of ‘fizzyness’ | Approximate P_{CO2} (bar) at 20° C. |
|---|---|
| Flat | ~≦1.0 |
| Lightly sparkling | 1.5 |
| Typical fizzy drink (e.g. cola) | 3.5 |
| Highly carbonated (e.g. mixer) | 4 |

With such drinks the headspace pressure decreases everytime the container, e.g. bottle, is opened, or decreases with time in the case of faulty packaging or packaging made of a relatively porous material. Such, usually unwanted, degassing increases with increasing temperature. The longer the bottle is left opened, the more CO₂ is lost from the system and the lower the eventual equilibrium headspace pressure due to CO₂ when the bottle is eventually resealed. By provision of an indicator according to the first aspect of the present invention, a measure of the CO₂ concentration/partial pressure, i.e. of the ‘fizzyness’ of a carbonated drink, may be easily and reliably obtained, thus providing a useful quality assurance tool to e.g. a retailer and/or a consumer.

Preferably, the indicator may be a colourimetric indicator.

The at least one reactive dye may be in equilibrium between at least two chemical forms or states.

Conveniently, the at least one reactive dye may exhibit a first colour in a first chemical form or state, and a second colour in a second chemical form or state.

Preferably, the first and second colours may be different.

Typically, the at least one reactive dye may comprise Phenol red (PR, phenolsulfonphthalein), Congo red (sodium salt of benzidinediazo-bis-1-naphthylamine-4-sulfonic acid), Neutral red (NR, toluoylene red), Chlorophenol red (2-chloro-4-[3-(3-chloro-4-hydroxyphenyl)-1,1-dioxobenzo[c]oxathiol-3-yl]phenol) and/or Brilliant yellow (disodium 5-[2-(4-hydroxyphenyl)diazen-1-yl]-2-(2-{4-[2-(4-hydroxyphenyl)diazen-1-yl]-2-sulfonatophenyl}ethenyl)benzene-1-sulfonate).

The indicator may comprise more than one type of reactive dye. By such provision, the indicator may be capable of detecting one or more changes, e.g. multiple changes, in the concentration/partial pressure of carbon dioxide, e.g. by providing reactive dyes that change colour at different concentrations/partial pressure of carbon dioxide.

The at least one reactive dye may comprise a water-soluble dye and/or a solvent-soluble dye.

Typically, the at least one reactive dye may comprise a water-soluble dye. By such provision, because water-soluble reactive dyes are typically less sensitive than solvent-soluble reactive dyes, the indicator may be capable of detecting one or more changes in the concentration/partial pressure of carbon dioxide at relatively high pressures of carbon dioxide, e.g. at pressures of CO₂ above approximately 1 bar.

Conveniently, the indicator may be provided in the form of an ink which may be coated onto a substrate such as a film, sheet, or the like.

Typically, the ink may comprise at least one polymer in which the at least one dye may be dispersed, e.g. polyvinyl alcohol (PVA), hydroxyethyl cellulose (HEC), hydroxypropyl cellulose (HPC), polyvinyl butyral (PVB), or the like.

The ink may further comprise a plasticizer, e.g. glycerol.

According to a second aspect of the present invention there is provided a method of preparing an ink according to a preferred embodiment of the first aspect of the present invention, comprising dissolving at least one carbon dioxide-sensitive reactive dye and at least one polymer in at least one solvent.

Typically, the at least one reactive dye may comprise Phenol red (PR, phenolsulfonphthalein), Congo red (sodium salt of benzidinediazo-bis-1-naphthylamine-4-sulfonic acid), Neutral red (NR, toluoylene red), Chlorophenol red (2-chloro-4-[3-(3-chloro-4-hydroxyphenyl)-1,1-dioxobenzo[c]oxathiol-3-yl]phenol) and/or Brilliant yellow (disodium 5-[2-(4-hydroxyphenyl)diazen-1-yl]-2-(2-{4-[2-(4-hydroxyphenyl)diazen-1-yl]-2-sulfonatophenyl}ethenyl)benzene-1-sulfonate).

The at least one polymer may comprise polyvinyl alcohol (PVA), hydroxyethyl cellulose (HEC), hydroxypropyl cellulose (HPC), polyvinyl butyral (PVB), or the like.

The at least one solvent may comprise water. In such instance, the at least one reactive dye may typically be a water-soluble dye.

Alternatively, the at least one solvent may be an organic solvent, e.g. ethanol. In such instance, the at least one reactive dye may typically be a solvent-soluble dye.

The method may further comprise adding and/or mixing a plasticizer, e.g. glycerol.

According to a third aspect of the present invention there is provided a method of preparing an indicator according to the first aspect of the present invention, comprising applying, e.g. coating, an ink according to a preferred embodiment of the first aspect of the present invention onto a substrate.

The method may further comprise evaporating the at least one solvent.

The substrate may comprise a film, a sheet, or the like.

The substrate may be made of e.g. glass, paper, or preferably may comprise a polymeric substrate, e.g. plastic.

The method may comprise applying the ink on the substrate so as to be capable of revealing information, e.g. a word or a symbol, upon colour change.

In one embodiment, the indicator may be capable of revealing a message or word, e.g. “low fizz” or “flat”, when a change, e.g. decrease, in CO₂ pressure/concentration causes a change in colour of the indicator/ink. Alternatively, or additionally, a message or word, e.g. “high fizz” may be visible above a predetermined concentration/pressure of CO₂, and may disappear when the concentration/pressure of CO₂ changes, e.g. decreases.

The substrate may also be coloured so as to match/correspond to an initial colour or altered colour of the indicator. In this way the ink can be printed in a particular manner so as to reveal or obscure an image in response to a change, e.g. decrease, in CO₂ pressure/concentration. For example, an indicator may be provided so as to take the form of a word such as “not” adjacent to a permanently visible word such as “fizzy”, the word “not” being invisible above a predetermined concentration/pressure of CO₂, and the word “not” becoming visible to an observer in response to a decrease in CO₂ pressure/concentration. Many other patterns, symbols or text can be envisaged, such as a set of bubbles being visible under high carbon dioxide pressure/concentration, followed by a cross appearing over the set of bubbles in response to a decrease in CO₂ pressure/concentration.

According to a fourth aspect of the present invention there is provided the use of a carbon dioxide indicator or an ink according to the first aspect of the invention and embodiments associated therewith, in detecting changes in carbon dioxide concentration in a fluid under high fluid and/or gas phase pressure, e.g. at pressures of CO₂ above approximately 1 bar (10⁵ Pa), preferably under carbon dioxide pressure between approximately 1 bar and approximately 10 bar, and typically under carbon dioxide pressure between approximately 1 bar and approximately 5 bar.

Advantageously, the use may comprise using an indicator or ink according to the first aspect of the present invention and embodiments associated therewith, in carbonated liquids containers, e.g. carbonated drinks containers such as carbonated drinks bottles, for example carbonated drinks plastic bottles. By such provision, a measure of the CO₂ concentration/partial pressure, i.e. of the ‘fizzyness’ of a carbonated drink, may be easily and reliably obtained, thus providing a useful quality assurance tool to e.g. a retailer and/or a consumer.

Alternatively, the use may comprise using an indicator or ink according to the first aspect of the present invention and embodiments associated therewith, in other applications involving high CO₂ pressures, e.g. brewing, fermentation, propellant-dispensing products, grain storage, industrial decaffeination of coffee, refrigeration, monitoring pressure of carbon dioxide as a raw material in industrial chemical reactions, carbon dioxide dry cleaning, fire extinguishers, carbon dioxide gas cylinders, bakeries, industrial fermentation in biotechnology for, e.g. drug manufacture, or the like.

According to a fifth aspect of the present invention there is provided a container for holding a carbonated liquid, such as a carbonated soft drink or alcoholic beverage, comprising an indicator or an ink according to the first aspect of the present invention and embodiments associated therewith.

The container may comprise a carbonated drinks container, such as a carbonated drinks bottle, e.g. a carbonated drinks plastic bottle.

The indicator or ink may be provided within or integral with the container and/or a closure of the container, e.g. an ink may be coated onto or incorporated in, e.g. an inside surface of the container, or an inside surface of a cap, lid or the like.

Alternatively, the indicator may be provided inside an internal volume of the container, e.g. as a strip, disc or the like, which may be connected, e.g. glued or otherwise attached, to a portion of the container, e.g. to an inside portion thereof.

The container may comprise at least one substantially transparent portion. By such provision a colour change of the indicator may be easily detected by an observer.

Typically, the container may be substantially wholly transparent.

Advantageously, the indicator may be liquid-proof, e.g. waterproof, e.g. by coating or laminating the indicator, e.g. with polyethylene terephthalate (PET) or ethylene vinyl acetate (EVA).

The indicator or ink may be capable or revealing information, e.g. a word or a symbol, upon colour change.

In one embodiment, the indicator may be capable of revealing a message or word, e.g. “low fizz” or “flat”, when a change, e.g. decrease, in CO₂ pressure/concentration causes a change in colour of the indicator/ink. Alternatively, or additionally, a message or word, e.g. “high fizz” may be visible above a predetermined concentration/pressure of CO₂, and may disappear when the concentration/pressure of CO₂ changes, e.g. decreases.

The substrate may also be coloured so as to match/correspond to an initial colour or altered colour of the indicator. In this way the ink can be printed or the indicator dispersed in a particular manner so as to reveal or obscure an image in response to a change, e.g. decrease, in CO₂ pressure/concentration. For example, an indicator may be provided so as to take the form of a word such as “not” adjacent to a permanently visible word such as “fizzy”, the word “not” being invisible above a predetermined concentration/pressure of CO₂, and the word “not” becoming visible to an observer in response to a decrease in CO₂ pressure/concentration. Many other patterns, symbols or text can be envisaged, such as a set of bubbles being visible under high carbon dioxide pressure/concentration, followed by a cross appearing over the set of bubbles in response to a decrease in CO₂ pressure/concentration.

According to a sixth aspect of the present invention there is provided a closure, e.g. a cap or a lid, for a container for holding a carbonated liquid, such as a carbonated soft drink or alcoholic beverage, comprising an indicator or an ink according to the first aspect of the present invention and embodiments associated therewith.

The container may comprise a carbonated drinks bottle, e.g. a carbonated drinks plastic bottle.

Typically, the closure, e.g. a cap or a lid, may be substantially airtight.

Conveniently, the closure may be cap, e.g. a conventional screw cap for, e.g. carbonated drinks plastic bottle. By such provision the cap may be fitted to conventional carbonated drinks plastic bottles so as to monitor the “fizzyness” of the carbonated fluid therein.

The indicator may be provided onto an internal surface of the closure, e.g. an ink may be coated onto an inside surface of the closure.

Alternatively, the indicator may be provided as an insert, e.g. strip, disc or the like, which may be connected, e.g. glued, clipped or otherwise attached, to an inside portion of the closure.

Alternatively, the indicator may be incorporated in the matrix of the closure material, e.g. dispersed within a polymer material comprising the closure, e.g. during manufacture of the closure such as during molding thereof. To achieve the necessary stability during such processes, the indicator may be coated onto and/or impregnated within a particulate inorganic substrate to form a particulate indicator having enhanced stability such as those described in British Patent Application No. GB 0918212.2 (University of Strathclyde).

The closure may comprise at least one substantially transparent portion. By such provision a colour change of the indicator may be easily detected by an observer.

Typically, the closure may be substantially wholly transparent.

Advantageously, the indicator may be liquid-proof, e.g. waterproof.

The indicator or ink may be capable or revealing information, e.g. a word or a symbol, upon colour change.

In one embodiment, the indicator may be capable of revealing a message or word, e.g. “low fizz” or “flat”, when a change, e.g. decrease, in CO₂ pressure/concentration causes a change in colour of the indicator/ink. Alternatively, or additionally, a message or word, e.g. “high fizz” may be visible above a predetermined concentration/pressure of CO₂, and may disappear when the concentration/pressure of CO₂ changes, e.g. decreases.

The substrate may also be coloured so as to match/correspond to an initial colour or altered colour of the indicator. In this way the ink can be printed or the indicator dispersed in a particular manner so as to reveal or obscure an image in response to a change, e.g. decrease, in CO₂ pressure/concentration. For example, an indicator may be provided so as to take the form of a word such as “not” adjacent to a permanently visible word such as “fizzy”, the word “not” being invisible above a predetermined concentration/pressure of CO₂, and the word “not” becoming visible to an observer in response to a decrease in CO₂ pressure/concentration. Many other patterns, symbols or text can be envisaged, such as a set of bubbles being visible under high carbon dioxide pressure/concentration, followed by a cross appearing over the set of bubbles in response to a decrease in CO₂ pressure/concentration.

### BRIEF DESCRIPTION OF DRAWINGS

Embodiments of the invention will now be given by way of example only, and with reference to the accompanying drawings, which are:

FIG. 1A table showing the various types of CO₂-sensitive reactive dyes used in the preparation of chemical indicators/dyes according to a first embodiment of the first aspect of the present invention;

FIG. 2 A UV/visible absorption spectrum of an ink according to an embodiment of the first aspect of the present invention showing absorbance at different pressures of CO₂, using PR as a reactive dye;

FIG. 3 A graph showing absorbance of the ink of FIG. 2 at 570 nm vs. P_{CO2} (insert: constant ‘R’ vs. P_{CO2}); and

FIG. 4 A photograph showing the colour change of the ink of FIG. 2 coated on a polypropylene sheet, when exposed to three different pressures of CO₂.

### EXAMPLES

### Preparation

Typical Water-Based High P_{CO2} Phenol Red Ink

A typical water-based high P_{CO2} ink was prepared by dissolving 0.400 g of Phenol red (PR, phenolsulfonphthalein sodium salt) in 10 cm³ of distilled water and adding 4 cm³ of 1.0M sodium hydroxide as base. The solution was stirred for 10-15 minutes. 4 cm³ of this solution was added to 6.00 g of 15% w/v polyvinyl alcohol in water (PVA, MW 146,000-186,000), along with 0.600 g glycerol as plasticizer. The resulting solution was stirred at room temperature for at least 30 minutes.

The relative contents in pphr (parts per hundred parts resin) of the various components of the PVA/PR/glycerol/NaOH ink thus prepared were 100/12.7/66.7/5.6 pphr.

The bright pink ink was spin-coated onto a borosilicate glass disc substrate using a spin coater at 2000 rpm for 10 seconds, forming an approximately 2 μm thick film indicator.

Alternative Inks Using Different CO₂-Sensitive Reactive Dyes

A variety of CO₂-sensitive reactive dyes were employed to make the indicators. A specific choice of dye can be made depending on the pressure range intended to be experienced by the indicator and/or the visual change of colour involved, as some particular colour changes may be more suitable than others for certain applications.

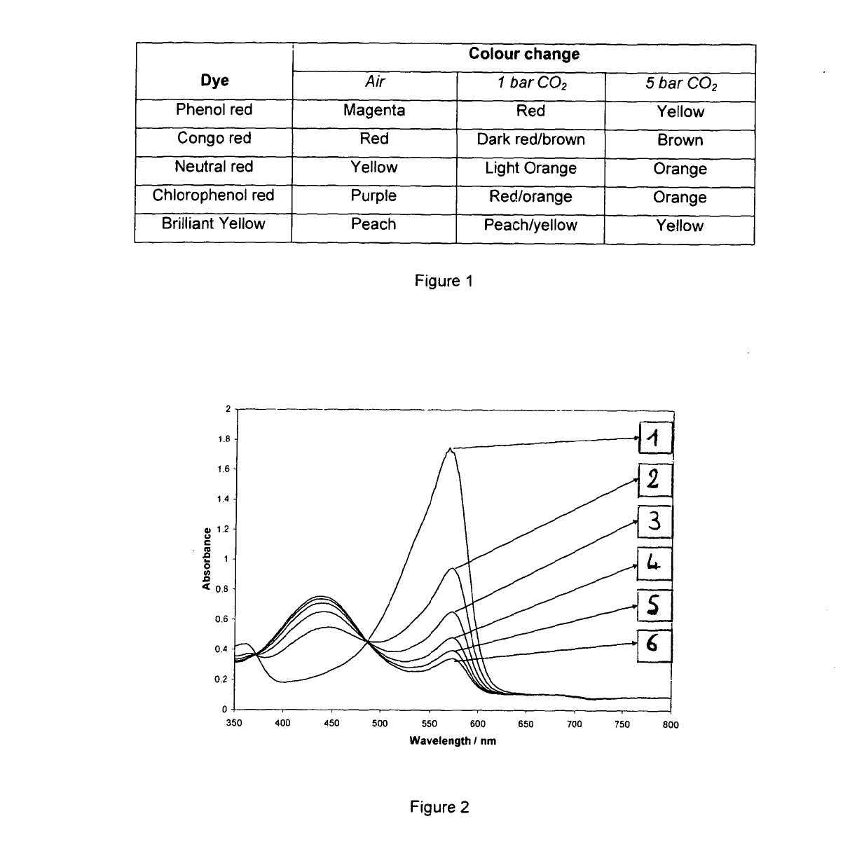

The Table presented in FIG. 1 shows the dyes that were used in the preparation of carbon dioxide-sensitive indicators, using the preparation method described above, and the corresponding colour change under different CO₂ pressures.

Alternative Inks Using Different Bases

Inks were made using the preparation method described above, replacing the 1.0M sodium hydroxide (NaOH) solution with an equal volume of a saturated solution of calcium hydroxide (Ca(OH)₂), magnesium hydroxide (Mg(OH)₂) or barium hydroxide (Ba(OH)₂). The inks made using the alternative bases led to similar inks and indicators as those prepared using NaOH.

Alternative Inks Using Different Polymers

Inks were made using the preparation method described above, replacing the 6.00 g of 15% w/v polyvinyl alcohol in water by 6.00 g of 5% w/v hydroxyethyl cellulose in water (HEC), or 6.00 g of 5% w/v hydroxypropyl cellulose in water (HPC). The ink made using HEC and HPC as alternative polymers led to similar inks and indicators as those prepared using PVA.

Alternative Inks Using Different Solvents

A typical solvent-based ink was prepared by adding 0.400 g of Phenol red in 10 cm³ of ethanol and 1.5 cm³ of 1.0 M sodium hydroxide in ethanol solution. The solution was stirred for 10-15 minutes. 4 cm³ of this solution was added to 6.00 g of a 50% w/v polyvinyl butyral in ethanol (PVB, Acros organics), along with 0.600 g of glycerol as plasticizer. The resulting solution was stirred at room temperature for at least 30 minutes.

The bright pink ink was spin-coated onto a borosilicate glass disc substrate using a spin coater at 2000 rpm for 10 seconds, forming an approximately 2 μm thick film indicator.

It was observed that the water-based inks were typically less sensitive than their counterpart solvent-based inks comprising the same carbon dioxide reactive dye(s). Therefore, for detection of changes in CO₂ concentrations under high pressures, water-based inks were preferred.

Preparation of Indicator Strips Using CO₂-Sensitive Inks

To demonstrate the use of the ink as a ‘fizzyness’ indicator for carbonated drinks, a typical water-based high P_{CO2} ink using Phenol red and prepared by the method described above was coated onto biaxially orientated polypropylene sheets (Goodfellow, 0.075 mm), which had been pre-treated with a 1 μm coating of polyvinyl butyral in ethanol (20% w/v) to improve film adhesion. The samples were then laminated using commercially available PET laminated pouches (150 μm thickness).

As shown in FIG. 4, the coloured strips 40 were inserted into standard polyethylene terephthalate (PET) carbonated drink bottles 41 which had caps 42 adapted with inlet 43 and outlet 44 valves. The inlet valve 43 was connected to a carbon dioxide cylinder to enable the pressure of carbon dioxide inside the bottle 41 to be controlled externally.

A first bottle was exposed to ambient atmospheric conditions.

A second bottle was pressurised to 1 bar CO₂, representing a ‘flat’ bottle of carbonated drink.

A third bottle was pressurised to 3 bar CO₂, representing a ‘fizzy’ bottle of carbonated drink.

The colour changes observed under the different CO₂ pressures were recorded and are shown in FIG. 4.

### Results

Typical Water-Based High P_{CO2} Phenol Red Ink

The absorbance spectrum of a standard film of a typical water-based high P_{CO2} ink using Phenol red and prepared by the method described above and spin-coated onto a borosilicate glass disc substrate was monitored via UV-visible absorption spectroscopy as a function of CO₂ pressure.

The results are illustrated in FIG. 2, in which the pressures of CO₂ were, from top to bottom at λₘₐₓ=570 nm (wavelength of maximum absorbance of the dye in its deprotonated form D⁻): air, 1 bar, 2 bar, 4 bar, 6 bar and 8 bar respectively.

As can be seen from FIG. 2, the absorbance of the ink at λₘₐₓ=570 nm decreases upon increasing CO₂ pressure, indicating a shift in the chemical equilibrium of the dye from its deprotonated from towards it protonated form.

FIG. 2 also show the respective colours of the ink under the different CO₂ pressures (air, 1 bar, 2 bar, 4 bar, 6 bar and 8 bar), from magenta 1 to dark orange 2, orange 3, light orange 4, dark yellow 5 and light yellow 6, respectively.

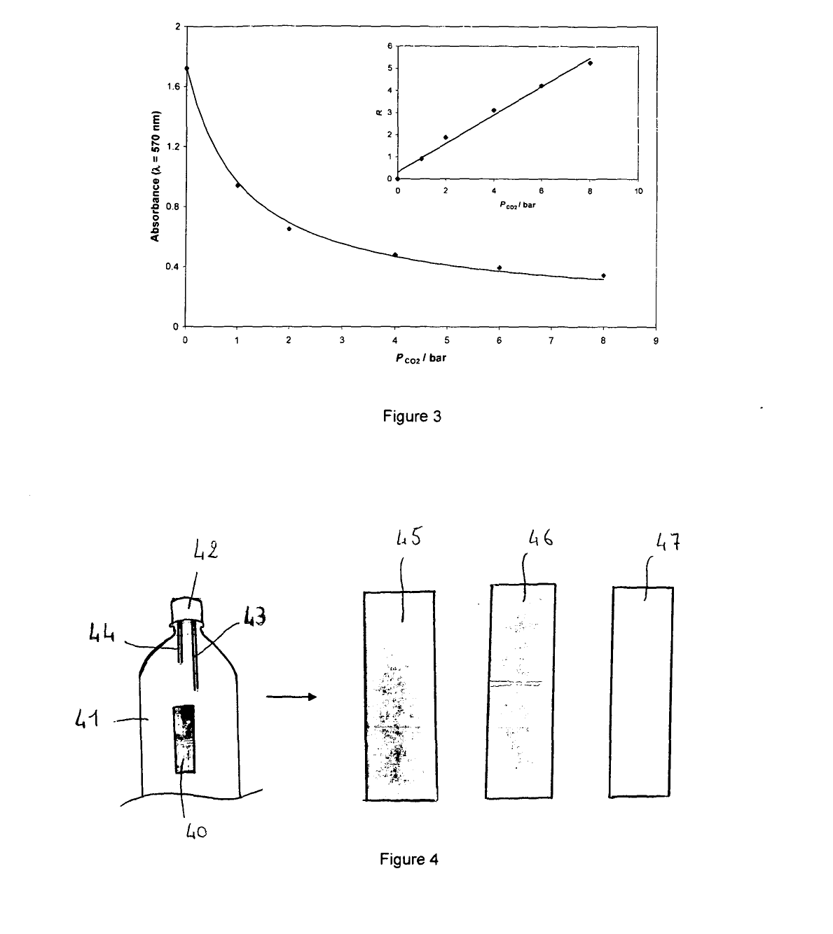

The absorbance of the dye at λₘₐₓ (570 nm), as a function of P_{CO2}, decreases hyperbolically as illustrated in FIG. 3.

It is usual and useful to define the parameter, R, based on experimentally measurable absorbance values at λₘₐₓ (of the dye in its deprotonated form D⁻) at different carbon dioxide pressures P_{CO2}, as follows:

R=(Abs₀−Abs)/(Abs−Abs_{∞})=[HD]/[D⁻] (Eq 1)

where:

Abs₀ is the value of absorbance of the dye at λₘₐₓ (D⁻) when P_{CO2}=0 (i.e. when all the dye is in its deprotonated form); and

Abs_{∞} the absorbance of the ink when all the dye has been converted into its protonated form (HD). Since the protonated form of the dye does not absorb significantly at λₘₐₓ (D⁻), it is convenient to take Abs_{∞} as that of the substrate alone (in this case the glass disc) at λₘₐₓ (D⁻).

Thus, R is a measure of the transformation of the dye from its deprotonated to protonated form and for such indicators it can be shown that:

R=[HD]/[D⁻]=α·P_{CO2} (Eq 2)

where α is the proportionality constant.

The absorbance versus P_{CO2} plot arising from the data in FIG. 2 is illustrated in FIG. 3. The insert in FIG. 3 also shows R versus P_{CO2}, calculated using this data and equation (Eq 1).

The linear relationship between R and P_{CO2}, as expected from equation (Eq 2) reveals an α value of 0.65±0.04 bar⁻¹.

Typical response and recovery times for the indicator when exposed to 3 bar CO₂ and back to ambient pressure were 22 and 54 minutes, respectively. The indicators were fully reversible and could be used repeatedly without any loss in performance.

Indicator Strips

The colour changes of the indicator strips prepared as described above observed under three different CO₂ pressures (air, 1 bar and 3 bar, respectively) are shown in FIG. 4.

As can be seen, the first strip 45 which was exposed to ambient atmospheric conditions was magenta in colour. The second strip 46 which was exposed to a CO₂ pressure of 1 bar was orangey red in colour. The third strip 47 which was exposed to a CO₂ pressure of 3 bar was yellow in colour.

An additional experiment was carried out using the same indicator, in which the contents of a carbonated drink bottle was progressively allowed to lose its ‘fizz’ (by removing cap and allowing to stand). The results showed the same colour changes as illustrated in FIG. 4, evidencing the reversibility of the indicators.

It is known in the art that CO₂-sensitive inks exhibit temperature sensitivity. Experiments were carried out, recording colour change of the indicators under varying CO₂ pressures at different temperatures (particularly at 4° C. (typical refrigerator temperature) and 20° C. (typical room temperature)). The experiments confirmed that CO₂ sensitivity increases with decreasing temperature. The experiment also confirmed that clear change of colour was still observed in the tested range of temperature between 1 and 3 bar.

Although FIG. 4 shows an embodiment of the present indicator as an indicator strip, it is to be understood that other embodiments may be envisaged for the indicator of the present invention.

In particular, the indicators or inks of the present invention may be provided within or integral with the container, e.g. an ink may be coated onto or incorporated within, e.g. an inside surface of the container, or an inside surface or a cap, lid or the like.

In an alternative embodiment, the indicator may be provided on or within a closure, e.g. a cap or a lid, for a container for holding a carbonated liquid, such as a carbonated soft drink or alcoholic beverage. In particular, the closure may comprise a cap such as a conventional screw cap for a carbonated drinks plastic bottle. By such provision the cap may be fitted to conventional carbonated drinks plastic bottles so as to monitor the “fizzyness” of the carbonated fluid therein.

1. A container for holding a carbonated liquid, comprising a carbon dioxide indicator or a carbon dioxide-sensitive ink, wherein the carbon dioxide indicator and/or the ink comprises at least one carbon dioxide-sensitive reactive dye which is capable of detecting changes in carbon dioxide concentration in a fluid under fluid and/or gas phase pressure of carbon dioxide above approximately 1 bar.

2. A container according to claim 1, wherein the container is a carbonated drinks bottle.

3. A container according to claim 1, wherein the indicator or ink is provided on, within or integral with the container and/or a container closure.

4. A container according to claim 3, wherein the indicator or ink is coated on an inside surface of the container and/or on an inside surface of a/the container closure.

5. A container according to claim 1, wherein the indicator or ink is provided inside an internal volume of the container.

6. A container according to claim 1, wherein the container comprises at least one substantially transparent portion.

7. A closure for use in a container according to claim 1, comprising a carbon dioxide indicator or a carbon dioxide-sensitive ink, wherein the carbon dioxide indicator and/or the ink comprises at least one carbon dioxide-sensitive reactive dye which is capable of detecting changes in carbon dioxide concentration in a fluid under fluid and/or gas phase pressure of carbon dioxide above approximately 1 bar.

8. A closure according to claim 7, wherein the closure comprises a screw cap.

9. (canceled)

10. (canceled)

11. (canceled)

12. A carbon dioxide indicator comprising at least one carbon dioxide-sensitive reactive dye which is capable of detecting changes in carbon dioxide concentration in a fluid under fluid and/or gas phase pressure of carbon dioxide above approximately 1 bar.

13. A carbon dioxide indicator according to claim 12, wherein the indicator is capable of detecting changes in carbon dioxide concentration in a fluid under carbon dioxide pressure between approximately 1 bar and approximately 10 bar, or under carbon dioxide pressure between approximately 1 bar and approximately 5 bar.

14. A carbon dioxide indicator according to claim 12, wherein the indicator is waterproof.

15. A carbon dioxide indicator according to claim 12, wherein the at least one carbon dioxide-sensitive reactive dye comprises a water-soluble dye.

16. A carbon dioxide indicator according to claim 12, wherein the indicator is a colourimetric indicator.

17. A carbon dioxide indicator according to claim 16, wherein the at least one carbon dioxide-sensitive reactive dye is selected from the list consisting of Phenol red (PR, phenolsulfonphthalein), Congo red (sodium salt of benzidinediazo-bis-1-naphthylamine-4-sulfonic acid), Neutral red (NR, toluoylene red), Chlorophenol red (2-chloro-4-[3-(3-chloro-4-hydroxyphenyl)-1,1-dioxobenzo[c]oxathiol-3-yl]phenol) and Brilliant yellow (disodium 5-[2-(4-hydroxyphenyl)diazen-1-yl]-2-(2-{4-[2-(4-hydroxyphenyl)diazen-1-yl]-2-sulfonatophenyl}ethenyl)benzene-1-sulfonate).

18. A carbon dioxide indicator according to claim 12, wherein the indicator is provided in the form of an ink.

19. A carbon dioxide indicator according to claim 18, comprising at least one polymer selected from the group consisting of polyvinyl alcohol (PVA), hydroxyethyl cellulose (HEC), hydroxypropyl cellulose (HPC) and polyvinyl butyral (PVB), and optionally further comprising a plasticizer such as glycerol.

20. A carbon dioxide indicator according to claim 18, comprising at least one solvent selected from the group consisting of water and ethanol.

21. A method of preparing a carbon dioxide indicator according to claim 18, comprising dissolving at least one carbon dioxide-sensitive reactive dye and at least one polymer in at least one solvent.

22. A method according to claim 21, further comprising applying the ink onto a substrate.

23. (canceled)

24. A container according to claim 1, wherein the carbon dioxide indicator comprises at least one carbon dioxide-sensitive reactive dye which is capable of detecting changes in carbon dioxide concentration in a fluid under fluid and/or gas phase pressure of carbon dioxide above approximately 1 bar.

25. A closure according to claim 7, wherein the carbon dioxide indicator comprises at least one carbon dioxide-sensitive reactive dye which is capable of detecting changes in carbon dioxide concentration in a fluid under fluid and/or gas phase pressure of carbon dioxide above approximately 1 bar.
